(19) United States
(12) Patent Application Publication
(10) Pub. No.: US 2005/0113157 A1
(43) Pub. Date: May 26, 2005

(54) Personal telecommunication device with two parts and pronounced potential for self-expression

(76) Inventor: Mikael Jaakola, Turku (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/509,402

(22) PCT Filed: Mar. 28, 2003
(86) PCT No.: PCT/FI03/00243

(30) Foreign Application Priority Data
Mar. 28, 2002 (FI) 20020614

(51) Int. Cl. H04B 5/00

(52) U.S. Cl. 455/575.6; 455/575.1; 455/566; 455/41.1

(57) ABSTRACT

A personal telecommunication device (100) for use as a mobile station of a digital cellular radio network comprises a keypad (105, 221) for allowing a human user to input information to the personal telecommunication device (100) and a display (103, 233) for displaying information to a human user of the personal telecommunication device (100). The personal telecommunication device (100) comprises two mechanically separate structural parts, of which a first part is a keypad part (102, 202, 302, 402, 502, 602, 702) that comprises the keypad (105, 221), and a second part is an amulet (101, 201, 301, 401, 501, 601, 701, 801, 1201) that comprises the display (103, 233). The personal telecommunication device (100) comprises a short distance communication link (106, 222, 231, 322, 331, 722, 731) between the keypad part and the amulet. The amulet (101, 201, 301, 401, 501, 601, 701, 801, 1201) comprises a hanging arrangement (104) by the help of which the amulet is adapted to be worn on the torso of a human user.

The invention concerns generally the technology of system level design of personal telecommunication devices. Especially the invention concerns the distribution of electrical and mechanical functions of a personal telecommunication device into certain structural entities. Additionally the invention concerns the various possibilities of using certain structural entities of a personal telecommunication devices also for other purposes than personal telecommunication, which possibilities arise from the implementation of electrical and mechanical functions in such structural entities.

The widespread introduction of cellular radio networks has caused a personal telecommunication device to become a more or less inseparable part of everybody's life. Conventional personal telecommunication devices were only mobile telephones, but the concept of a personal telecommunication device is rapidly evolving towards encompassing also other kinds of features that previously were only associated with so-called PDAs (Personal Digital Assistants). Consumers are naturally demanding ease of use as well as functional versatility that would allow replacing conventionally separate devices (mobile telephone, PDA, portable computer, portable locating device) with a single apparatus. However, consumers are also keen on personalizing their communication devices so that the appearance and functionality of a personal telecommunication device would reflect the personality and mood of its user. Examples of known ways for personalizing a telecommunication device include exchangeable coloured and patterned covers, selectable ringing tones and downloadable logos that are to appear on a display while the telecommunication device is currently not used for anything else.

Despite of ongoing serious efforts of large groups of research workers around the world it is apparent that an ultimately versatile personal telecommunication device remains to be seen. It is thus an objective of the present invention to provide a system level design for a personal telecommunication device that would enhance versatility regarding both functionality and potential for personalization. It is another objective of the present invention to enhance the potential of a personal telecommunication device as means for self-expression.

The objectives of the invention are achieved by distributing certain functionalities of a personal telecommunication device into two mechanically separate structural entities, one of which is adapted to be worn on the torso of a user, preferably hung around the neck of a user.

A personal telecommunication device according to the invention is characterized by the features that are recited in the characterizing part of the independent patent claim directed to a personal telecommunication device.

The invention applies also to an accessory of a personal telecommunication device. An accessory of a personal telecommunication device according to the invention is characterized by the features that are recited in the characterizing part of the independent patent claim directed to an accessory of a personal telecommunication device.

During the research work that resulted in the present invention it was noted that the mere system design of conventional personal telecommunication devices places limitations both to usability and to potential for self-expression. The conventional system design is a remnant of the earliest generations of digital cellular telephones, regarding which it was considered as a major achievement when a fully functional mobile telephone could be realised in one piece the size of which allowed it to be conveniently held in one hand. Since then the system design of personal telecommunication devices has followed more or less slavishly the approach where the device has the form of a generally rectangular prism with two large side surfaces, one of which has a display and a loudspeaker within the upper half of the surface and a small keypad and a microphone within the lower half of the surface. Indeed it has been considered to involve courage and commercial risk-taking to make even small changes to the conventional design, like placing keys on both sides of the display as in the Nokia 5510 model that became commercially available throughout the world towards the end of year 2001.

A first aspect of the present invention involves making the personal telecommunication device to comprise two mechanically separate parts, which in this description are referred to as the amulet and the keypad part. Of these, the amulet is adapted to be worn on the torso of a user, preferably hung around the neck of a user. The amulet includes a display and the keypad part includes a keypad. The distribution of other components and functionalities into the amulet and the keypad part depends on which embodiment of the invention is selected and will be described in more detail later.

The possibility of wearing the amulet on one's torso or hanging it around one's neck as well as the fact that the amulet includes a display makes the personal telecommunication device according to the invention an ideal tool for self-expression. The user can change the aesthetic appearance of the amulet as well as the graphical or alphanumeric message communicated through the display as often as he wishes. Because there is a separate keypad part there is only little need for providing the amulet with keys, which helps to make the amulet conveniently small and ornament-like to be regarded as a necklace, pendant or brooch.

A second aspect of the present invention assumes the division of a personal telecommunication device into an amulet and a keypad part, and involves additionally providing the amulet with communication capabilities through which the amulet can communicate with other devices than the keypad part. Such communication capabilities serve to greatly enhance the functional versatility of the amulet, because it can then be used independently of the keypad part for various purposes. For example there may be a game console into which the amulet fits so that the display in the amulet can be used for playing recreational games. A more earnest application could involve plugging the amulet of a maintenance worker into an appliance to be serviced and using it for displaying logged data or error condition indicators.

A third aspect of the invention involves complementing the personal telecommunication device that comprises an amulet and a keypad part with a third structural entity that appears in this description under the designation display panel. As its name suggests, the display panel includes a display that is remarkably larger than the display in the amulet. A larger display panel with loudspeakers optionally coupled thereto is useful for tasks such as viewing received multimedia messages or following audiovisual broadcastings.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

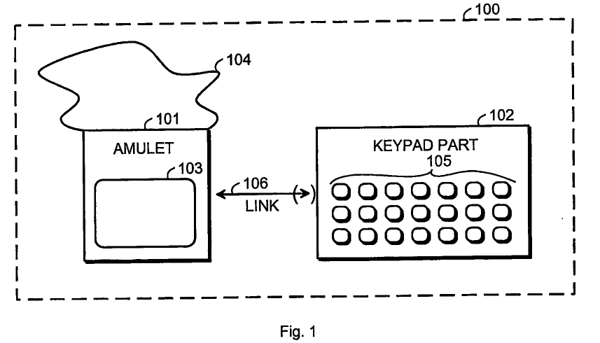

FIG. 1 illustrates the division of a personal telecommunication device into two parts,

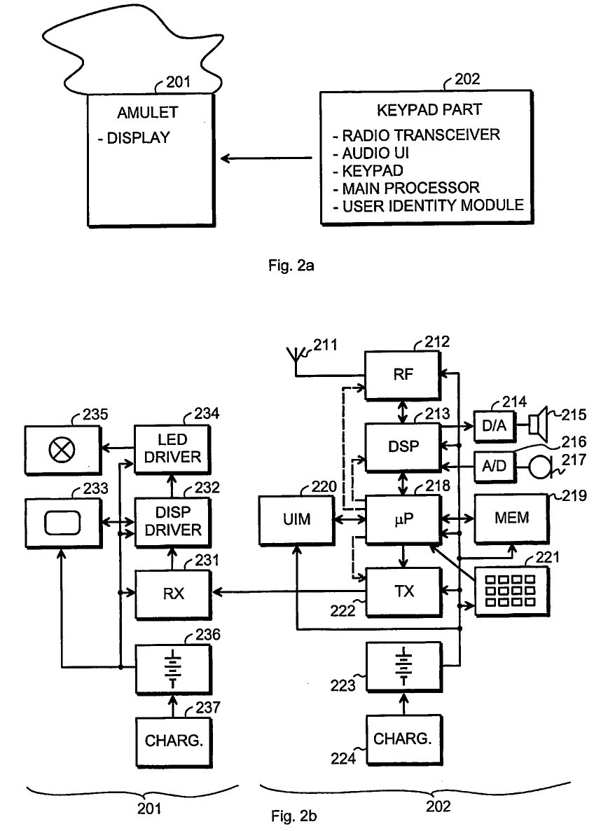

FIGS. 2a and 2b illustrate the distribution of functionalities according to a first embodiment of the invention,

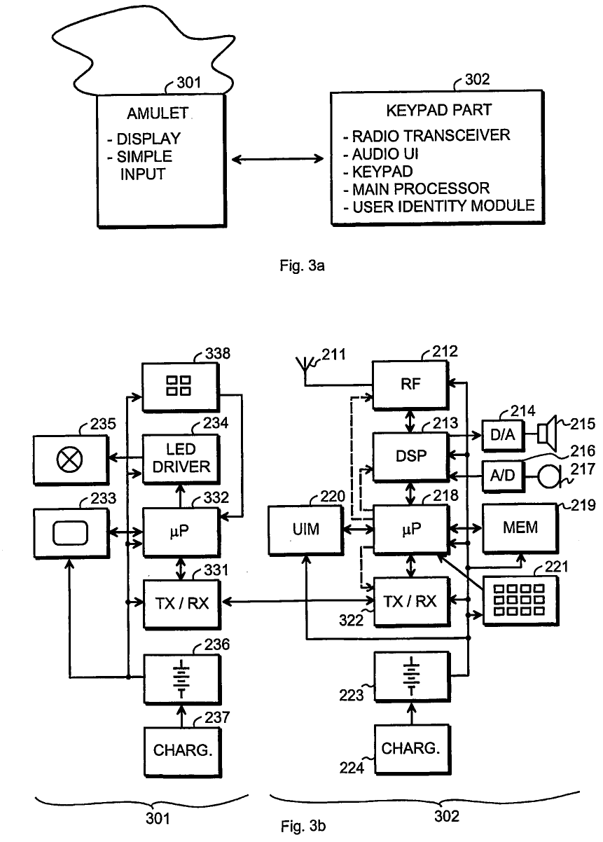

FIGS. 3a and 3b illustrate the distribution of functionalities according to a second embodiment of the invention,

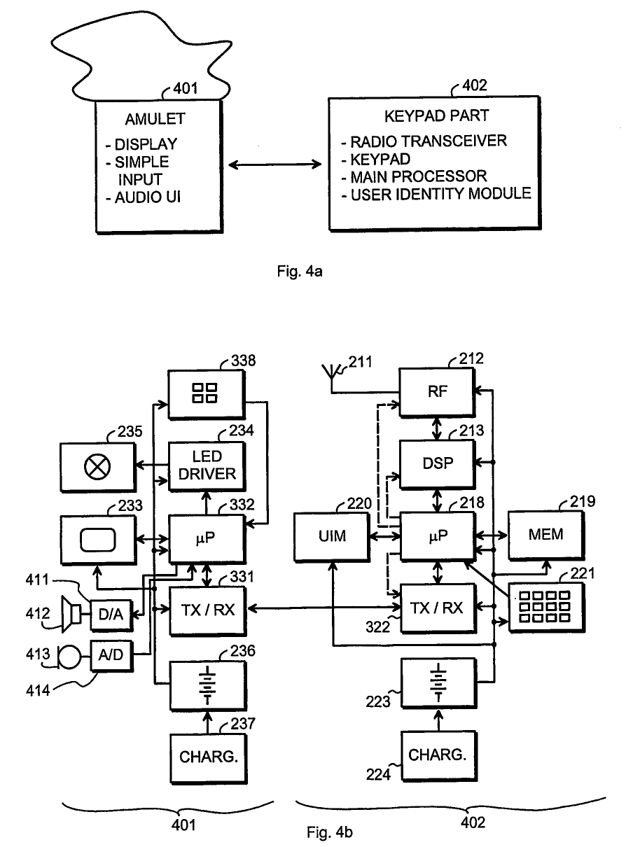

FIGS. 4a and 4b illustrate the distribution of functionalities according to a third embodiment of the invention,

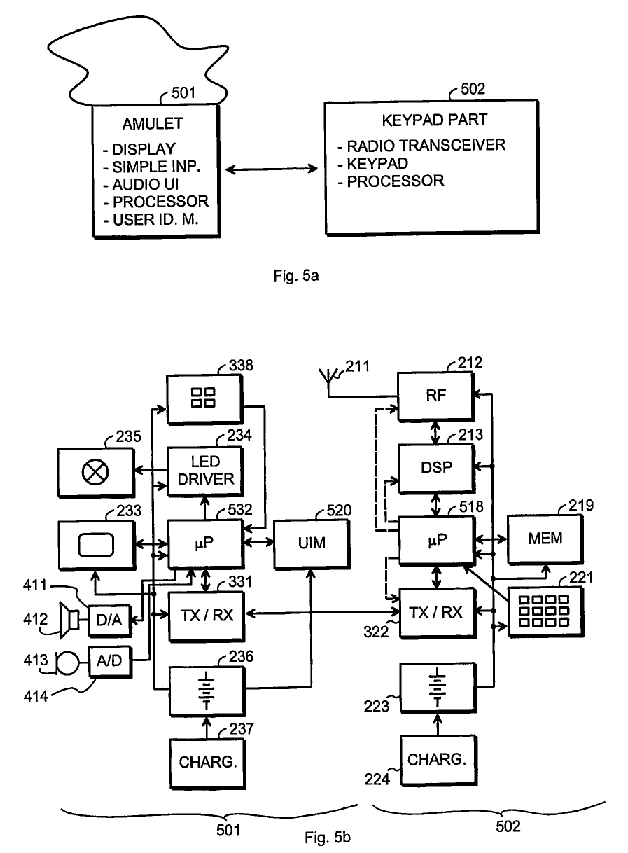

FIGS. 5a and 5b illustrate the distribution of functionalities according to a fourth embodiment of the invention,

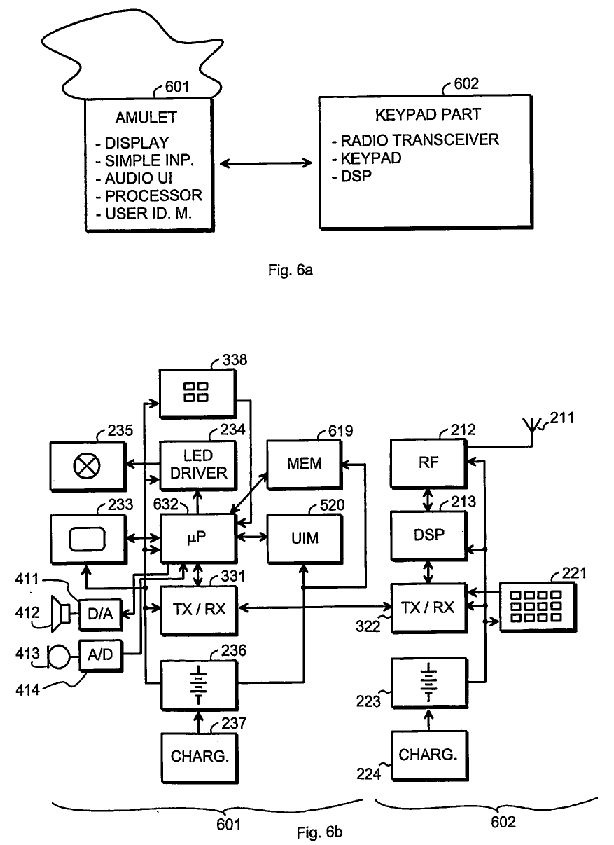

FIGS. 6a and 6b illustrate the distribution of functionalities according to a fifth embodiment of the invention,

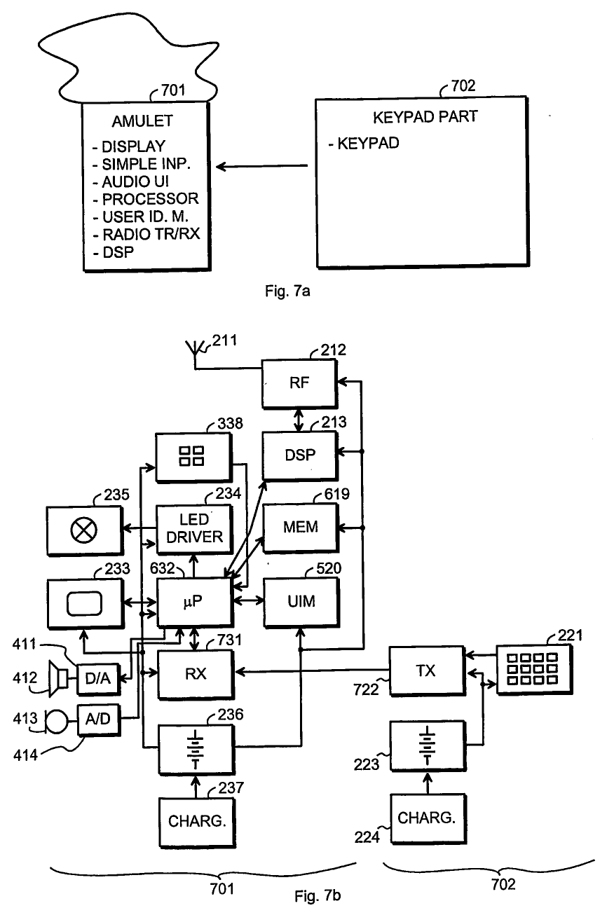

FIGS. 7a and 7b illustrate the distribution of functionalities according to a sixth embodiment of the invention,

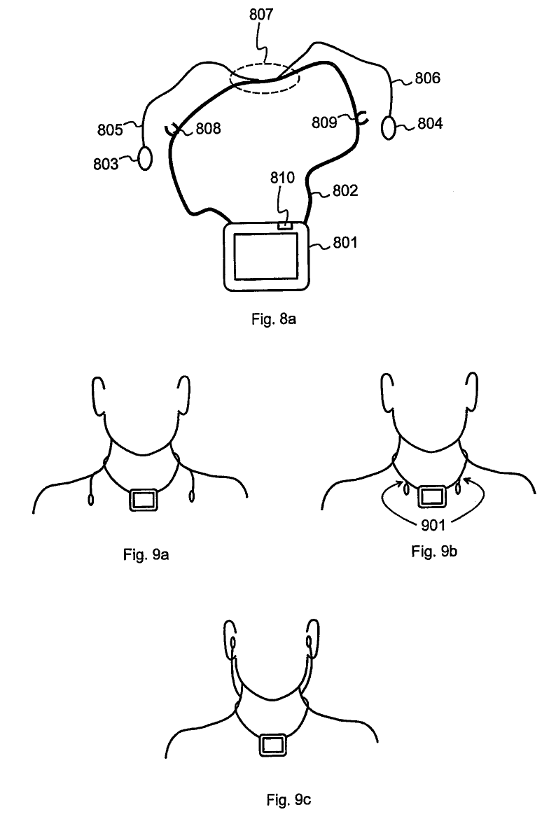

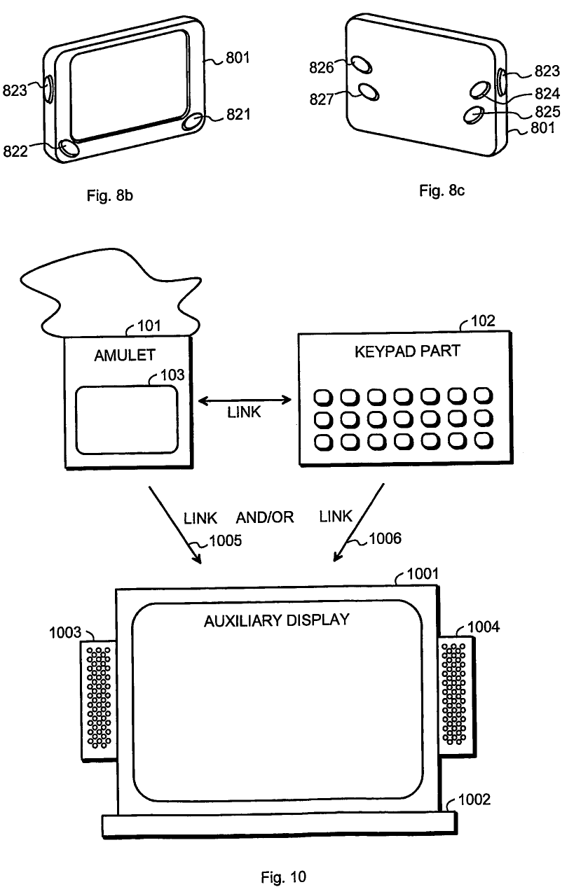

FIG. 8a illustrates an amulet according to an embodiment of the invention with transducers,

FIGS. 8b and 8c illustrate certain alternatives of placing pressable keys in the amulet,

FIGS. 9a, 9b and 9c illustrate the use of the amulet shown in FIG. 8a,

FIG. 10 illustrates augmenting a personal telecommunication device according to the invention with a larger display,

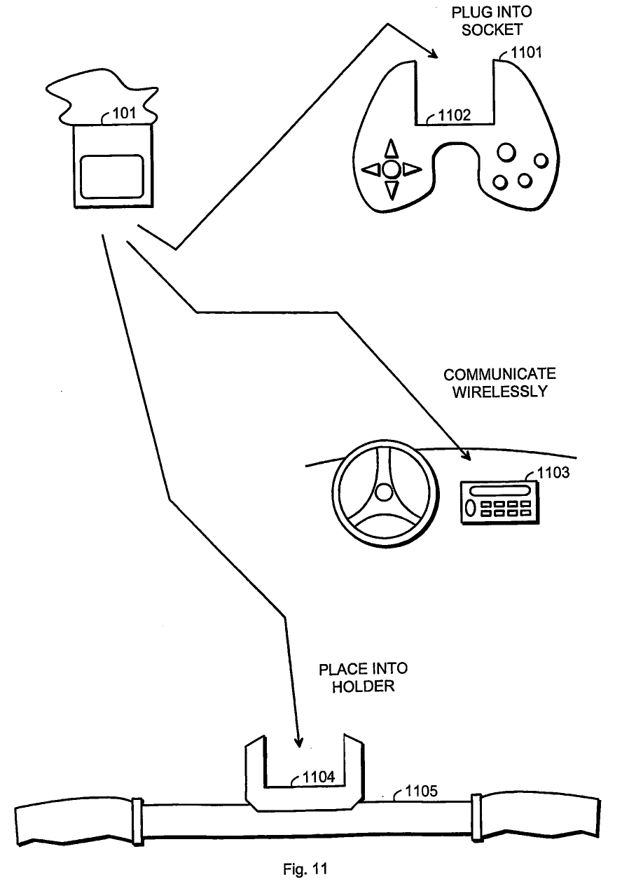

FIG. 11 illustrates an amulet according to an embodiment of the invention communicating with other devices, and

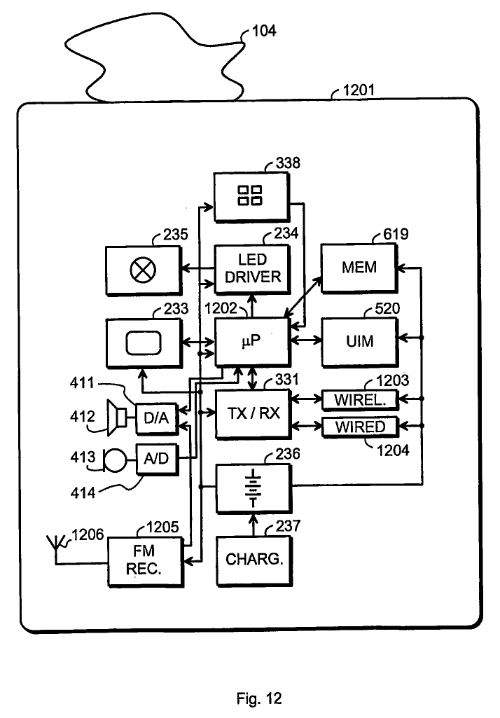

FIG. 12 illustrates the components of an amulet according to an embodiment of the invention.

The exemplary embodiments of the invention presented in this patent application are not to be interpreted to pose limitations to the applicability of the appended claims. The verb “to comprise” is used in this patent application as an open limitation that does not exclude the existence of also unrecited features. The features recited in depending claims are mutually freely combinable unless otherwise explicitly stated.

Two-Part Personal Telecommunication Device in General

FIG. 1 illustrates a personal telecommunication device 100 according to an embodiment of the present invention. The personal telecommunication device 100 comprises two separate parts, namely the amulet 101 and the keypad part 102. The most prominent feature of the amulet 101 is a display 103 that is adapted to display graphics, images and alphanumeric characters. Another important feature of the amulet 101 is a hanging arrangement 104 with the help of which the amulet 101 is adapted to be worn on the torso of a user of the personal telecommunication device 100. In FIG. 104 the hanging arrangement 104 appears in the exemplary form of a string, but it could also have the appearance of a needle, a safety pin, a velcro patch or any other means known e.g. from the field of attaching jewellery onto a person's torso. Within the context of this description the amulet 101 together with its hanging arrangement 104 are meant to externally appear as a necklace, a pendant or a brooch. The most prominent feature of the keypad part 102 is a keypad 105 that consists of pressable or otherwise actuatable keys. There is a communications link 106 between the amulet 101 and the keypad part. Most advantageously the communications link 106 is bidirectional, but embodiments of the invention can be realised even with a unidirectional communications link the transmission direction of which is from the keypad part 102 to the amulet 101.

If the personal telecommunication device 100 is to be useful for personal telecommunication, it must also comprise other features, such as a transceiver for communicating with the fixed parts of cellular radio systems, a processor for effecting and controlling the operation of the personal telecommunication device, an acoustoelectric transducer (a microphone) for recording the user's speech, an electroacoustic transducer (a loudspeaker) for reproducing audio signals as well as the batteries or other storages of electric energy that are necessary for keeping the device operative regardless of location. A feature that is useful but not absolutely necessary is a user identity module for storing subscriber-specific information, which user identity module is separate from the main processor. Additional features of the personal telecommunication device 100 may include a camera for taking digital images or video cilosand an FM receiver for receiving radio broadcastings. In the following we give certain examples of how the other features could be distributed into the amulet and the keypad part.

Distribution of Features Into the Two Parts

An important division can be made between so-called “amulet engine” embodiments and “keypad part engine” embodiments of the invention. In the framework of personal telecommunication devices as they are known at the priority date of this description the concept of engine is understood to encompass the intelligence and network communication functions of the device. In other words the engine concept includes the main processor that effects and controls the operation of the device, the memory that the processor uses for accomplishing its tasks, as well as the signal processor and radio transceiver that the main processor uses for communicating with the fixed parts of cellular radio systems. We will first discuss “keypad part engine” embodiments, where the engine is located within the keypad part.

Placing the engine into the keypad part has certain advantages at least when the level of technology known at the priority date of this description is taken into account. The generation of radio transmissions towards the base stations of cellular radio systems is easily the most power-hungry application in known personal telecommunication device, which means that the radio transceiver should be located in that part of the personal telecommunication device that includes the largest battery, which is typically the keypad part because less stringent size and weight requirements apply to it than to the amulet. The amulet is also adapted to be worn directly against the body of the user, which means that if the amulet was to exchange radio transmissions with base stations, substantial loss of otherwise useful radiation energy could occur through absorption to the user's body. The keypad part is more likely to be in a pocket or a bag or on a tabletop, with correspondingly less absoprtion of radiation to the user's body. On the other hand the interplay between the radio transceiver and the main processor is quite intimate, which tends to discourage a system designer from separating the parts of the engine from each other.

FIGS. 2a and 2b illustrate schematically certain functionalities and electrical components of a personal telecommunication device according to a first “keypad part engine” embodiment of the invention. The left-hand side components are located in an amulet 201 and the right-hand side component are located in a keypad part 202. Among the latter there are an antenna 211 and a radio transceiver 212 coupled thereto for receiving radio signals from the base stations of cellular radio systems and for transmitting radio signals to such base stations. Bidirectionally coupled to the radio transceiver 212 there is a digital signal processor 213 for implementing baseband processing of received signals and signals to be transmitted. From the digital signal processor 213 there is a coupling through a D/A converter 214 to a transducer 215 for reproducing audio signals. The digital signal processor 213 is also coupled through an A/D converter 216 to a microphone 217 for recording audio signals. Further there is a bidirectional coupling from the digital signal processor 213 to the main processor 218 of the personal telecommunication device.

The main processor 218 has bidirectional couplings to a memory 219 and a user identity module 220. Additionally there are unidirectional couplings from a keypad 221 to the main processor 218 and from the main processor 218 to a short distance transmitter block 222. The main processor 218 is also adapted to control the operation of the radio transceiver 212, the digital signal processor 213 and the short distance transmitter block 222; these control connections are shown as dashed lines. A battery 223 provides electrical energy to all components that need it. There is also an arrangement 224 for coupling the battery 223 to an external power source for charging the battery.

Within the amulet-side components 201 there is a short distance receiver block 231 that is adapted to receive transmissions from the short distance transmitter block 222 of the keypad part. Since the amulet is in this embodiment mainly a display unit, the main functional component of it is a display driver 232 that is coupled to receive information from the short distance receiver block 231 and to drive a display 233 so that the received information results in appropriate visual effects on the display 233. In order to illuminate the display 233 there may be a connection from the display driver 232 to a light source driver 234 and further to suitably located light sources 235. The amulet needs a battery 236 of its own to provide the other components with electrical energy, as well as an arrangement 237 for coupling the battery 236 to an external power source for charging the battery.

Although the amulet 201 of FIGS. 2a and 2b is a very simple one compared with amulets according to certain other embodiments of the invention, it has certain important advantages. The fact that the amulet only needs to receive and never needs to transmit makes it easy to keep the overall power consumption of the amulet very low. Despite of its simplicity the amulet 201 manages to offer remarkable potential for self-expression, because the display will be always visible at the upper front part of the user's torso. The amulet 201 is always readily available for its user to check, whether new messages have arrived or whether there is something else in the status of the personal telecommunication device that would require the user to fetch the keypad part 202 into reach. The amulet 201 may also take on the functions of a personal watch, simply by making the display 233 constantly show the time.

For the reasons of pronounced potential for self-expression as well as easy checking of time and phone status one could even consider producing amulets of the kind shown in FIG. 2 to be used as an accessory to otherwise complete mobile telephones. If we assume that a mobile telephone supports Bluetooth or some other convenient short distance communication protocol, making use of an “add-on” amulet would only require programming the mobile telephone so that is transmits all information that goes into its own display driver (or a suitable selected part thereof) also to an amulet through the Bluetooth connection.

FIGS. 3a and 3b illustrate another “keypad part engine” embodiment of the invention. The difference compared to the embodiment of FIGS. 2a and 2b is that in FIGS. 3a and 3b the amulet 301 can also be used for providing simple input to the personal telecommunication device. Thus the previously unidirectional link between the keypad part 302 and amulet 301 is now replaced with a bidirectional one, with short distance transceivers 322 and 331 at its ends. The short distance transceiver 322 of the keypad part now has a bidirectional coupling with the main processor 218 of the keypad part. A simple display driver has been replaced with a more versatile processor 332 in the amulet; the coupling between it and the short distance transceiver 331 of the amulet is naturally also bidirectional. The amulet now comprises input means 338 for enabling a human user to give simple input commands to his personal telecommunication device. The input means 338 typically include a small number of pressable keys and/or a touch-sensitive layer on top of the display 233.

Moving still more functionalities from the keypad part to the amulet results in the third “keypad part engine” embodiment shown in FIGS. 4a and 4b. The amulet is by its nature typically located closer to the user's mouth and ears than the keypad part, so the amulet may be used as the platform for the audio user interface of the personal telecommunication device. The amulet 401 in FIGS. 4a and 4b comprises a D/A converter 411 for coupling a transducer 412 to the processor 332. Additionally the amulet 401 comprises a microphone 413 that is coupled through an A/D converter 414 to the processor 332. Several variations of this embodiment may be presented depending on how the audio processing functions are distributed between the processor 332 of the amulet 401 and the DSP 213 and main processor 218 of the keypad part 402. Factors that should be taken into account in distributing the audio processing functions involve processing power (which processor has the necessary processing capacity), consumption of electrical energy (from which of the batteries 237 and 224 should the energy be drawn for the processing) as well as the capacity of the short-distance link between the amulet 401 and the keypad part 402 (how could the use of the short-distance link be optimised). It may be necessary to use a built-in digital signal processor in the processor 332 of the amulet to fulfil the necessary audio processing tasks.

Of the amulet and the keypad part the former is more readily perceived as a very personal and user-specific object, which may prompt placing a user identity module 520 into an amulet 501 rather than into a keypad part 502, as is shown in FIGS. 5a and 5b. Assuming that the processor 518 of the keypad part 502 is still the main processor of the personal telecommunication device, one must note that for accessing features or data that are stored in the user identity module 520 the processor 518 must now communicate through the short-distance transceivers 322 and 331 as well as the processor 532 of the amulet 501 (although there may also be a connection directly between the short distance transceiver block 331 and the user identity module 520 in the amulet 501). The embodiment of FIGS. 5a and 5b has the advantage that the amulet 501 can be used independently of the keypad part 502 for purposes where such user-specific information is needed that typically resides in a user identity module. A compromise regarding the location of a user identity modules would be to use two separate user identity modules, one in each of the amulet and the keypad part. The module in the amulet could be used for storing data and algorithms that relate to other uses of the personal telecommunication device (or the amulet alone), while the module in the keypad part would include the data and algorithms that are related to the subscription contract between the user and a telecommunications operator.

FIGS. 6a and 6b illustrate an intermediate form between “keypad part engine” and “amulet engine” embodiments of the invention, because in FIGS. 6a and 6b the intelligence of the personal telecommunication device is located in the amulet 601 but the network communication functions of the device are located in the keypad part 602. The processor 632 of the amulet 601 is adapted to control all operations of the personal telecommunication device (the control connections are not shown in FIG. 6b for the sake of clarity). The main memory 619 of the personal telecommunication device is also located in the amulet 601. The processing capacity of the keypad part 602 is restricted into a digital signal processor 213 that is adapted to perform the processing that is required for receiving and transmitting digital information from and to a digital cellular radio network.

FIGS. 7a and 7b illustrate a pure “amulet engine” embodiment of the invention where the keypad part 702 is little more than a non-intelligent wireless keyboard. The DSP 213, the radio transceiver 212 and the antenna 211 are all located in the amulet 701. The short distance link may again be unidirectional, with a transmitter 722 in the keypad part 702 and a receiver 731 in the amulet 701.

Mechanical and Electrical Considerations

FIGS. 8 and 9a to 9c illustrate certain mechanical considerations that apply to those embodiments of the invention in which the hanging arrangement of the amulet 801 is a string loop 802 to be worn around the neck of a user and in which the amulet 801 includes transducers 803 and 804. Here we assume that the transducers 803 and 804 are of the “button” or “earplug” type that are to be placed at the outer end of the outer auditory canal when in use. It is not obligatory that the personal telecommunication device includes two transducers; one would suffice at least if the device is not meant to be used as a stereo FM receiver. The cords 805 and 806 of the transducers run along the hanging string 802 for a certain length from the amulet proper 801. The point 807 where the cords 805 and 806 diverge from the hanging string 802 is most advantageously located around the middle point of the string 802. The string 802 or the cords 805 and 806 may comprise clips 808 and 809 for removably attaching the loose ends of the cords 805 and 806 to the string 802. FIG. 8 also illustrates how the microphone 810 can be located in the amulet 801. An alternative would be to place the microphone into a certain location along the string 802 or the transducer cords 805 or 806. A microphone in the middle of a cord leading to a transducer is known as such from many ultralight hands-free accessories of mobile telephones.

FIGS. 8b and 8c illustrate some alternatives of how the optional pressable keys can be placed into the amulet 801. There may be keys 821 and 822 on the front side of the amulet, keys 823 around the edge of the amulet as well as keys 824, 825, 826 and 827 on the back side of the amulet. The hanging arrangement of the amulet is not shown in FIGS. 8b and 8c for the reasons of graphical clarity.

The amulet comprises preferably a power switch for switching an operating power of the amulet on and off. Such a power switch may affect only the operating power of the amulet, or a power switch in the amulet can act as a remote control power switch for the keypad part, or a one and only power switch may have both effects. In the last-mentioned case it is possible to separate the different meanings of actuating the power switch for example by making a difference between a long press and a short press of a key, or by using any other known way of using a single switch for several purposes depending on the way of actuating the switch. Physically the power switch may take e.g. the form of a pressable key, or a functionality associated with a touch-sensitive screen of the amulet.

In FIG. 9a we assume that there are no clips for the loose ends of the transducer cords, so when the user wears the amulet the transducers hang freely. In FIG. 9b the clips exist at locations 901 and are in use, so the transducers hang in a more controlled manner near the amulet. FIG. 9c shows how the user plugs the transducers into his ears when using them for listening. In FIGS. 9a to 9c the length of the hanging string is shown to be relatively short: for practical use where it should be easy for the user to grab the amulet and lift it into a convenient eyeing position the string might be a little longer. Naturally there are also the alternatives of making the string extendable or flexible, or making the attachment of the amulet proper to the string so easily detachable that the user can always detach the amulet proper for eyeing.

For the sake of completeness we may consider the mechanical implementation of transducers if they are part of the keypad part rather than the amulet. The keypad part may include one or more fixed loudspeakers within its covers, or the transducer(s) may be attachable to the keypad part through a cord or cords. If the transducers are a part of the keypad part, then the keypad part is the most obvious choice also as the platform for the FM receiver, if any is included in the personal telecommunication device.

Other mechanical considerations relate to the size of the display in the amulet. According to the invention the display should be available for use for the user himself like the displays of conventional personal telecommunication devices, but also as self-expression means so that a person passing by or otherwise looking at the user could easily see the text or image that appears on the display. These purposes of use place restrictions to the size of the display. Practically the display can hardly be smaller than about 1×1,5 cm, because information that appers on a display smaller than that would not be easily perceivable. On the other hand the display should not be larger than about 6×8 cm, because otherwise the amulet might easily become too clumsy for practical use as a pendant, necklace or brooch.

The form of the amulet or the position in which it is worn on the torso are not important to the invention. The drawings demonstrate basically rectangular forms for the amulet, but the amulet could as well be circular, ellipsoidal or of any other form. Even if the amulet is basically rectangular, it is not necessary to hang it from two corners: it could be hung e.g. from one corner only so that it hangs diagonally.

Some consideration may be given to the practical realisation of the link between the keypad part and the amulet. Most preferably the link is wireless, which means that it employs infrared radiation or radio waves. Numerous commercially available technologies exist for realising a wireless link over a short distance, including but not being limited to an infrared link according to the IrDA standard and a Bluetooth radio link. As an alternative there may be a wired link between the keypad part and the amulet. A yet other alternative is to have a receptive socket in the keypad part into which the amulet is plugged every time when the two of them are to be used together.

Augmenting The Device with a Larger Display

FIG. 10 shows how a personal telecommunication device according to the invention may optionally be augmented with an auxiliary larger display part 1001, the display of which is remarkably larger than that 103 in the amulet 101 and which is most advantageously equipped with support means 1002 for keeping it in a convenient position on a tabletop or the like. The display 1001 may also have loudspeakers 1003 and 1004. For the purposes of using the auxiliary display part 1001 together with a personal telecommunication device according to the invention there must be a (unidirectional) short distance link to the display part 1001 either from the amulet 101 or from the keypad part 102. The alternative links are shown in FIG. 10 as link 1005 between the amulet 101 and the larger display part 1001 and link 1006 between the keypad part 102 and the larger display part 1001. Even both links may be used. The technology used for realizing the links may be the same as in the link between the amulet 101 and the keypad part 102. An auxiliary larger display part 1001 is useful for example for reproducing multimedia messages or other received graphical information, or during chat sessions where it is good to see more of the ongoing discussion at one glance than what can be shown in the small display 103 of the amulet 101.

Using the Amulet Independently of the Keypad Part

The fact that the amulet and keypad part are mechanically separate entities and each have their own batteries makes a big difference between a personal telecommunication device according to the invention and those relying on conventional technology. Even both parts may be used independently of each other, but for the purposes of the present invention using the amulet independently is far more important.

The amulet is a pronouncedly visual entity. Firstly, a large portion (more than half) of its most readily visible surface consists of a display, which is a visual communication device. Secondly, the amulet is adapted to be worn on the torso of a user, preferably hung around the neck of a user or fastened to clothing on the upper front part of the torso, with the display side clearly visible from the spatial sector in front of the user. This means that the amulet is visible within that part of its user that traditionally catches the largest part of other people's attention, and that the main displaying direction of the amulet faces oncoming other people. Thirdly, the absence of any actual keypad makes the amulet appear more like an ornament or jewel than like an electronic device. The ornamental aspect of the amulet can be further strengthened by equipping it with exchangeable covers of different colours and designs, which are conceptually and technically known as such from many mobile telephones.

The visuality of the amulet makes it a great instrument for visual self-expression. If amulets come in various models, each user may pick the model that best suits his personal taste. Even more importantly the user may select and/or download various logos, text messages, graphical images, video clips etc. to be constantly or repeatedly shown in the display of his amulet. Depending on the flexibility of the lighting arrangements that the amulet comprises, the user may also use lighting effects to complement the message given by the display: e.g. a pulsating red backlight on the display conveys a clearly different kind of self-expression than just a plain white backlight or no backlight at all. The amulet may comprise a light detector for detecting the level and characteristics of ambient lighting, and coupled to the light detector an automatic circuit for controlling the lighting of the display according to a certain set of rules that take the level and characteristics of ambient lighting into account.

The amulet is typically very light in weight (in the order of only some tens of grams) and relatively small in size (only a couple of centimeters each side). This together with the fact that the amulet has a hanging arrangement makes it easy to assume that users will like to keep their amulets with them wherever they go. There are several independent uses of the amulet that can be regarded as consequences of the ease of carrying it around. Firstly, the amulet may be used as the storage for digital keys, digital certificates, digital entrance tickets, e-cash, or in general any digital records that represent the user's right to obtain some services or commodities. When such a record needs to be presented for inspection, the amulet may respond to a command given by the user or to a wirelessly received inquiry from the inspecting apparatus by presenting the appropriate record in graphical form (alphanumeric string, bar code, encoded digital image etc.) on the display. Another alternative for presenting digital records for inspection is to use the short distance transceiver that the amulet uses for communicating with the keypad part. Secondly, the amulet may comprise a clock with all auxiliary functions typically associated with digital clocks (alarm, timekeeping, time signal, intermediate time etc.). Thirdly, the amulet may comprise a digital calendar with programmable reminder features for reminding the user of appointments. Fourthly, the amulet may comprise a digital memo pad for storing notes, shopping lists and other important documents that were originally imported to the amulet through the keypad part or even through independent input means like a touch-sensitive display in the amulet.

FIG. 11 shows how the amulet may communicate with other devices than the keypad part. The other device may have a receptive socket into which the amulet 101 is plugged; an example of this kind is the play console 1101 in FIG. 11 with a socket 1102 at its central part. A plug-in coupling makes the use of galvanic connectors very convenient, so we assume that the amulet 101 and the receptive socket 1102 comprise a mutually matching pair of connectors (not specifically shown in FIG. 11). Assuming that the amulet 101 comprises a short distance transceiver for communicating wirelessly with the keypad part, the amulet 101 may also set up wireless connections with other devices that are within the range of the short distance transceiver and that comprise a matching short distance wireless transceiver. As an example, FIG. 11 shows how the amulet may communicate with the on-board computer 1103 of the user's car. The other device may also have a simple mechanical holder 1104 for the amulet; here the other device is the handle bar 1105 of an exercise bike. If the exercise bike is computer-controlled, it might make sense to make an amulet placed in the mechanical holder 1104 to communicate with the control computer. Otherwise the mechanical holder just helps the user to enjoy music from the amulet's FM receiver or use the amulet in some other independent way during exercise.

In all applications where the amulet is to communicate with other devices than the keypad part the user may utilize the amulet's capability of storing information related to himself. For example in the exercise bike case the amulet may store the user's personal training profiles and communicate them to the control computer of the exercise bike at the beginning of a training session. Using the display of the amulet when communicating with other devices has the advantage that the user may obtain information that the other device could not easily provide otherwise. In professional use the other device may be a technical apparatus to be serviced, which apparatus does not have a display of its own. A maintenance worker who comes to service the apparatus may plug his amulet into a suitable socket in the apparatus. The apparatus first checks cryptograhically protected identification data in the amulet to ensure that the maintenance worker has the required authorization, and then utilizes the display in the plugged-in amulet to show logged error data or other information that is useful for the servicing task.

The communication capability of the amulet with other devices could well encompass the capability of communicating with other amulets. For example it might be advantageous if the user of an amulet could exchange logos with users of other amulets locally without involving network connections. If the amulet can be used for playing recreational games, the amulet to amulet connection would offer the possibility of users playing against each other. Technically an amulet to amulet connection requires only that the amulets have been programmed to follow a certain connection protocol when instructed to contact another amulet.

Implementation Example of Versatile Amulet

Certain technical implementations of exemplary amulets according to the invention have already been described with reference to FIGS. 2a to 7b. The amulet of FIG. 12 is another example that serves to illustrate certain technical features that underline the amulet's potential for independent use and self-expression. The amulet is enclosed in an exchangeable design cover 1201 and comprises a hanging arrangement 104 by the help of which the amulet is adapted to be worn on the torso of a human user. The central functional unit of the amulet is a processor 1202 that is adapted to control the operation of the amulet; the control connections from the processor 1202 to the other components are not shown in FIG. 12 for the reasons of graphical clarity. The processor 1202 utilizes a short distance transceiver block 331 for setting up bidirectional communication connections both with a keypad part (not shown) and with other devices like those shown in FIG. 11. The short distance transceiver block 331 has both a wireless communication interface 1203 and a wired communication connector 1204 at its disposal.

A central task of the processor 1202 is to drive a display 233 and through a lighting driver 234 its lighting arrangement 235. The display should all the time be kept up to date regarding the state of the personal communicating device: the user will every now and then like to check the display for example to look for indications of newly arrived messages, and the user can skip looking for the keypad part in his pockets if the display does not indicate that new messages would have arrived.

All user-specific information, or at least all such information that relates to the user as a subscriber to a certain telecommunications network, is stored in a user identification module 520, which is basically a storage of data but can also include processing functionality. Further storage space is provided in a memory 619 that the processor 1202 utilizes for storing program codes and other data. For example the communication protocols that the amulet should obey in setting up and maintaining communication connections with other devices (including a keypad part) are stored in the memory 619. At least one of the user identification module 520 and the memory 619 is adapted to store exchangeable logos and other graphical information that the user wishes to show in the display 233 for the purpose of self-expression. Audio interface parts 411, 412, 413 and 414 are also included for setting up an audio interface towards the user. Simple input means 338 are provided for giving the user a possibility of controlling the operation of the amulet even without resorting to the use of a keypad part.

The amulet of FIG. 11 also includes an FM receiver 1205 with a built-in antenna 1206 for receiving FM broadcastings. The FM receiver 1205 is coupled to the D/A converter 411 of the transducer 412 for acoustically reproducing the FM broadcastings. The FM reception antenna 1206 may be internal to the amulet, but it may also utilize the hanging string of the amulet if a hanging string exists. An antenna may be woven into or otherwise integrated with the hanging string, so that the outer appearance of the amulet does not suffer from any protruding antenna parts. The designation “FM receiver” is generic and covers all kinds of receivers that can be used to receive wireless broadcasts.

A rechargeable battery 236 provides all other components of the amulet with electric energy. For recharging the battery 236 there is a charging connection interface 237.

An interesting compromise between versatility and simplicity would be an amulet that would only comprise the parts shown as the amulet components in FIGS. 2a and 2b, with the addition of an FM receiver and associated transducer(s) as shown in FIG. 12. The user could use such a hybrid amulet mainly as an FM receiver that is particularly easy to carry around, with the delightful exception to normal radio receivers that the amulet would also tell the user the current status of his mobile telephone and act as self-expression means.

At least in certain embodiments of the invention it is advantageous to make the amulet and the keypad part mechanically incompatible, so that they can not be coupled mechanically to each other.

1. A personal telecommunication device (100) for use as a mobile station of a digital cellular radio network, comprising:
a keypad (105, 221) for allowing a human user to input information to the personal telecommunication device (100) and
a display (103, 233) for displaying information to a human user of the personal telecommunication device (100),
characterized in that
the personal telecommunication device (100) comprises two mechanically separate structural parts, of which a first part is a keypad part (102, 202, 302, 402, 502, 602, 702) that comprises the keypad (105, 221), and a second part is an amulet (101, 201, 301, 401, 501, 601, 701, 801, 1201) that comprises the display (103, 233),
the personal telecommunication device (100) comprises a short distance communication link (106, 222, 231, 322, 331, 722, 731) between said keypad part and said amulet,
said amulet (101, 201, 301, 401, 501, 601, 701, 801, 1201) comprises a hanging arrangement (104) by the help of which said amulet is adapted to be worn on the torso of a human user, and
said amulet comprises a microphone (413) and an electroacoustic transducer (412) for setting up an audio interface between the personal telecommunication device (100) and a human user.

2. A personal telecommunication device according to claim 1, characterized in that said keypad part (202, 302, 402, 502) comprises a main processor (218, 518) adapted to control the operation of the personal telecommunication device (100), as well as a radio transceiver (212) coupled to said main processor (218, 518) for arranging bidirectional radio communication between the personal telecommunication device (100) and a digital cellular radio network.

3. A personal telecommunication device according to claim 2, characterized in that the short distance communication link between said keypad part and said amulet is a unidirectional link (222, 231) from said keypad part to said amulet.

4. A personal telecommunication device according to claim 2, characterized in that said amulet comprises input means (338, 413), and the short distance communication link between said keypad part and said amulet is a bidirectional link (322, 331) adapted to convey input information from said input means (338, 413) in said amulet to said main processor (218, 518) in said keypad part.

5. A personal telecommunication device according to claim 2, characterized in that said keypad part (202, 302) comprises a microphone (217) and an electroacoustic transducer (215) for setting up an audio interface between the personal telecommunication device (100) and a human user.

6. A personal telecommunication device according to claim 1, characterized in that in addition to said microphone (413) said amulet comprises other input means (338) that comprise at least one pressable key (821, 822, 823, 824, 825, 826, 827).

7. A personal telecommunication device according to claim 1, characterized in that in addition to said microphone (413) said amulet comprises other input means (338) that comprise a touch screen integrated with said display (103, 233).

8. A personal telecommunication device according to claim 1, characterized in that said amulet comprises a power switch for switching an operating power on and off.

9. A personal telecommunication device according to claim 1, characterized in that said amulet (501, 601, 1201) comprises a main processor (532, 632, 1202) adapted to control the operation of the personal telecommunication device (100), and said keypad part comprises a radio transceiver coupled to said main processor through a bidirectional short distance communication link between said keypad part and said amulet for arranging bidirectional radio communication between the personal telecommunication device and the digital cellular radio network.

10. A personal telecommunication device according to claim 1, characterized in that said amulet (701) comprises a main processor (632) adapted to control the operation of the personal telecommunication device (100), as well as a radio transceiver (212) coupled to said main processor (632) for arranging bidirectional radio communication between the personal telecommunication device (100) and a digital cellular radio network.

11. A personal telecommunication device according to claim 10, characterized in that the short distance communication link between said keypad part and said amulet is a unidirectional link (722, 731) from said keypad part (702) to said amulet (701).

12. A personal telecommunication device according to claim 1, characterized in that it comprises
a third mechanically separate structural part (1001), which is a display part and comprises a display that is larger than the display (233) in said amulet, and
a short distance communication link (1005, 1006) between said display part (1001) and the other parts (101, 102) of the personal telecommunication device.

13. A personal telecommunication device according to claim 1, characterized in that
said keypad part is a mobile station of a cellular radio network and as such functionally completely independent of said amulet,
said mobile station comprises a general purpose short distance transceiver for setting up and maintaining short distance communication connections with other devices, and
said mobile station is adapted to transmit a copy of certain information destined to a display in said mobile station to said amulet through said general purpose short distance transceiver.

14. A personal telecommunication device according to claim 1, characterized in that said amulet is adapted to communicate with other devices in addition to said keypad part.

15. A personal telecommunication device according to claim 14, characterized in that said amulet comprises a connector for connecting it into a receptive socket in another device.

16. A personal telecommunication device according to claim 1, characterized in that said amulet is mechanically incompatible with said keypad part.

17. An amulet part (101, 201, 301, 401, 501, 601, 701, 801, 1201) for a personal telecommunication device, characterized in that it comprises:
a display (233) for displaying information to a human user of the personal telecommunication device,
short distance receiving means (231, 331, 1203, 1204) for receiving information to be presented in said display from another part of the personal telecommunication device and
a hanging arrangement (104) by the help of which the amulet part is adapted to be worn on the torso of a human user.

18. An amulet part according to claim 17, characterized in that said hanging arrangement (104) comprises a string (802) the two ends of which are attached to a body of the amulet part so that the string constitutes a loop.

19. An amulet part according to claim 18, characterized in that it comprises an electroacoustic transducer (803, 804) at the end of a cord (805, 806) extending from said body of the amulet part, a certain length of which cord is attached to said string (802).

20. An amulet part according to claim 19, characterized in that it comprises two electroacoustic transducers (803, 804), each of them being located at the end of a cord (805, 806) extending from said body of the amulet part, so that a certain length of each cord is attached to said string (802) and between said certain length and the transducer at the end of the cord each cord hangs free from attachments to said string.

21. An amulet part according to claim 17, characterized in that it comprises a broadcast receiver (1205) for receiving radio broadcasts.

22. An amulet part according to claim 17, characterized in that it comprises memory means (520, 619) for storing graphical information that is adapted to be shown on said display as a logo.
